(19) United States
(12) Patent Application Publication
(10) Pub. No.: US 2025/0389950 A1
(43) Pub. Date: Dec. 25, 2025

(54) Monolithic Microelectromechanical Systems Based Spatial Light Modulators Including Multiple Arrays, Each Array Configured To Modulate Different Wavelengths

(71) Applicant: SILICON LIGHT MACHINES CORPORATION, San Jose, CA (US)

(72) Inventors: Stephen Hamann, Mountain View, CA (US); Alexander Payne, Ben Lommond, CA (US); James Hunter, Campbell, CA (US); Tianbo Liu, San Jose, CA (US); Lars Eng, Los Altos, CA (US)

(73) Assignee: SILICON LIGHT MACHINES CORPORATION, San Jose, CA (US)

(21) Appl. No.: 19/248,351

(22) Filed: Jun. 24, 2025

Related U.S. Application Data
(60) Provisional application No. 63/663,245, filed on Jun. 24, 2024.

(51) Int. Cl. G02B 26/08

(52) U.S. Cl. CPC G02B 26/0841

(57) ABSTRACT

A monolithic spatial light modulator (SLM) is provided. Generally, the SLM includes a substrate with a number of substrate electrodes in a surface thereof, multiple MEMS-based linear arrays formed on the surface of the substrate, and a drive circuit monolithically integrated in the substrate below the surface of the substrate. Each linear array includes multiple ribbons suspended above the surface of the substrate, each ribbon having a light reflective surface facing away from the surface of the substrate, the plurality of ribbons including electrostatically displaceable ribbons, each electrostatically displaceable ribbon further including a ribbon electrode. The drive circuit is electrically coupled to the substrate and the ribbon electrodes, and is operable to apply drive voltages thereto. Each of the linear arrays is dimensionally and/or electrically tuned to modulate a different, non-overlapping range of wavelengths or a specific wavelength, for example, red, green and violet-blue wavelengths in the visible spectrum.

### CROSS-REFERENCE TO RELATED APPLICATIONS

This application claims the benefit of priority under 35 U.S.C. 119(e) to U.S. Provisional Patent Application Ser. No. 63/663,245 filed Jun. 24, 2024, which is incorporated by reference herein in its entirety.

### TECHNICAL FIELD

This disclosure relates generally relates to spatial light modulators (SLMs), and more particularly to monolithic SLMs including multiple microelectromechanical systems-based linear arrays, each configured to modulate a different wavelength.

### BACKGROUND

Spatial light modulators (SLMs) include an array of one or more modulators that can control or modulate an incident light in a spatial pattern that corresponds to an electrical input to the modulators. One type of SLM is an electrically addressable; microelectromechanical systems (MEMS) based SLM, such as a Grating Light Valve (GLV™) commercially available from Silicon Light Machines, in San Jose CA. This type of SLM generally includes an array of active-ribbons suspended over a surface of a substrate, each ribbon having a first, light reflective surface that may be moved or deflected relative to another ribbon or to a second, passive or static light reflective surface that be formed on a surface of the substrate or on a static ribbon. Each active-ribbon and adjacent static light reflective surface forms a single diffractor or ribbon-pair. The ribbon-type SLM modulates incident light by deflecting one or more of active-ribbons in the array relative to the second, passive or static light reflective surface towards the surface of the substrate, bringing a coherent light reflected from the active light reflective surface into interference with coherent light reflected from the static light reflective surface. The electrostatic force generated by a drive voltage from a drive-circuitry or drive circuit coupled to the substrate-electrode and ribbon-electrodes.

Generally, the active-ribbons must be able to be deflected by an odd multiple of one quarter (¼) of the wavelength of the incident light in order to provide full grey scale modulation of the incident light. One shortcoming of prior MEMs-based SLMs is that a maximum distance by which an active ribbon can be displaced is determined and limited by physical dimensions characteristics of the ribbon, including length, thickness, elasticity, a gap between a central portion of the ribbon and the surface of the substrate. Further limits include a limitation on a maximum drive voltage that can be applied between the substrate and ribbon electrodes due to the electrical components of the drive circuit.

Accordingly, there is a need for a SLM capable of modulating light having different, non-overlapping range of wavelengths.

### SUMMARY

An integrated or monolithic spatial light modulator (SLM) including a substrate with a number of substrate electrodes in a surface thereof, multiple microelectromechanical systems (MEMS) based linear arrays on the surface of the substrate, and a drive circuit monolithically integrated in the substrate below the surface of the substrate is provided. The multiple linear arrays are laterally adjacent along long sides thereof, and each includes multiple ribbons suspended above the surface of the substrate, each ribbon having a light reflective surface facing away from the surface of the substrate. The plurality of ribbons include a number of electrostatically displaceable ribbons, each electrostatically displaceable ribbon further including a ribbon electrode. The drive circuit is electrically coupled to the number of substrate electrodes and to the ribbon electrodes, and is operable to apply drive voltages thereto to electrostatically displace the ribbons toward the substrate to modulate light reflected from the reflective surfaces thereof by diffraction with light reflected from light reflective surface of other ribbons or a static light reflective surface on the surface of the substrate. Each of the linear arrays is dimensionally and/or electrically tuned to modulate a different, non-overlapping range of wavelengths or a specific wavelength, for example, red, green and violet-blue wavelengths in the visible spectrum.

In some embodiments, the plurality of electrostatically displaceable ribbons in each of the MEMS linear arrays include one or more of a length, a thickness, or a gap separating a central portion of the electrostatically displaceable ribbons from the surface of the substrate that is different from the plurality of electrostatically displaceable ribbons in the other MEMS linear arrays, to dimensionally tune each of the multiple MEMS linear arrays to optimally modulate a different, non-overlapping range of wavelengths. In general, the longest wavelength tuned ribbon will be able to modulate the shorter wavelengths, but it will not be optimally tuned for those lower wavelengths, e.g. in quiescent bright or dark states.

In other embodiments, the drive circuit includes a multiple drive circuit architecture including multiple digital-to-analog-converters (DACs), each DAC operable to receive digital image data and to generate a voltage to drive a number of pixels in only one of the multiple linear arrays to electrically tune each of the linear arrays to modulate light in different, non-overlapping range of wavelengths. In some of these embodiments, each linear array overlays one or more substrate electrodes not electrically coupled to substrate electrodes underlying the other linear arrays, and the drive circuit is operable to apply a different voltage to the substrate electrodes underlying each of the linear arrays to electrically tune each of the multiple MEMS linear arrays to modulate a different, non-overlapping range of wavelengths.

Further features and advantages of embodiments of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to a person skilled in the relevant art(s) based on the teachings contained herein.

### BRIEF DESCRIPTION OF THE DRAWINGS

Embodiments of the invention will now be described, by way of example only, with reference to the accompanying schematic drawings in which corresponding reference symbols indicate corresponding parts. Further, the accompanying drawings, which are incorporated herein and form part of the specification, illustrate embodiments of the present invention, and, together with the description, further serve to explain the principles of the invention and to enable a person skilled in the relevant art(s) to make and use the invention.

FIG. 1A is a perspective view of a portion of a Micro-Electromechanical Systems (MEMS) based linear array including both active and stationary active ribbons;

FIG. 1B is a schematic block diagram of a sectional side view of the portion of the linear array of FIG. 1A in an active or diffraction state;

FIG. 2A is a perspective view of a portion of a MEMS-based linear array including only active ribbons spaced apart to expose a reflective surface on a substrate;

FIG. 2B is a schematic block diagram of a sectional side view of the portion of the linear array of FIG. 2A in an active or diffraction state;

FIGS. 3A to 3E are schematic block diagrams of active ribbons in three abutting MEMS-based linear array illustrating embodiments for mechanically or dimensionally tuning each of the linear arrays to modulate a different, non-overlapping range of wavelengths;

FIG. 4 is a schematic block diagram of a top views of a monolithic spatial light modulator (SLM) including multiple MEMS-based linear arrays and a drive circuit integrally fabricated in a single substrate;

FIGS. 5A to 5F are schematic block diagrams of a sectional side view of active ribbons in FIG. 4 illustrating embodiments for dimensionally and electrically tuning each of the linear arrays to optimally modulate a different, non-overlapping range of wavelengths;

FIGS. 6A and 6B are graphs of intensity versus voltage (IV) for three MEMS-based linear arrays modulating different, non-overlapping range of wavelengths and illustrating the IV response for untuned versus mechanically or dimensionally tuned arrays;

FIG. 7A is a perspective view of a portion of a monolithic SLM including multiple MEMS-based linear arrays and window or optically transparent cover having anti-reflective coatings (ARC) above each array specific to a wavelength modulated by each array;

FIG. 7B is a planar top view of the portion of the monolithic SLM of FIG. 7A;

FIG. 7C is a schematic block diagram of a sectional side view of the monolithic SLM of FIG. 7A illustrating a cylindrical lens above each array;

FIG. 8A is a top view of an embodiment of two ribbons in a MEMS-based linear array with split or slotted ribbons;

FIG. 8B is a top view of another embodiment of two ribbons in a MEMS-based linear array with arbitrary openings therein;

FIG. 9 is a schematic block diagram of an exemplary architecture for a monolithic SLM including three MEMS-based linear arrays of 1200 pixels each and a drive circuit with 3600 total drive channels;

FIGS. 10A to 10C are schematic block diagrams of different embodiments of multiple drive circuit architecture for use in the monolithic SLM of FIG. 9;

FIG. 11 is a schematic block diagram of an optical system including a monolithic SLM with multiple dimensionally and electrically tuned MEMS-based linear arrays;

FIGS. 12A and 12B are optic diagrams illustrating illumination and imaging light paths for the system of FIG. 11; and

FIG. 13 is a flowchart of a method for fabricating a monolithic SLM including multiple dimensionally and electrically tuned MEMS-based linear arrays.

The features and advantages of embodiments of the present invention will become more apparent from the detailed description set forth below when taken in conjunction with the drawings. In the drawings, like reference numbers generally indicate identical, functionally similar, and/or structurally similar elements.

### DETAILED DESCRIPTION

Embodiments of monolithic spatial light modulators (SLM) including multiple microelectromechanical systems (MEMS) based linear arrays formed on a surface of a substrate and a drive circuit integrally formed in the substrate are provided. Each MEMS-based linear array is dimensionally and electrically tuned to modulate a different, non-overlapping range of wavelengths or a specific wavelength.

In the following description, numerous specific details are set forth, such as specific materials, dimensions and processes parameters etc. to provide a thorough understanding of the present invention. However, particular embodiments may be practiced without one or more of these specific details, or in combination with other known methods, materials, and apparatuses. In other instances, well-known semiconductor design and fabrication techniques have not been described in particular detail to avoid unnecessarily obscuring the present invention. Reference throughout this specification to “an embodiment” means that a particular feature, structure, material, or characteristic described in connection with the embodiment is included in at least one embodiment of the invention. Thus, the appearances of the phrase “in an embodiment” in various places throughout this specification are not necessarily referring to the same embodiment of the invention. Furthermore, the particular features, structures, materials, or characteristics may be combined in any suitable manner in one or more embodiments.

The terms “over,” “under,” “between,” and “on” as used herein refer to a relative position of one layer with respect to other layers. As such, for example, one layer deposited or disposed over or under another layer may be directly in contact with the other layer or may have one or more intervening layers. Moreover, one layer deposited or disposed between layers may be directly in contact with the layers or may have one or more intervening layers. In contrast, a first layer “on” a second layer is in contact with that second layer. Additionally, the relative position of one layer with respect to other layers is provided assuming operations deposit, modify and remove films relative to a starting substrate without consideration of the absolute orientation of the substrate.

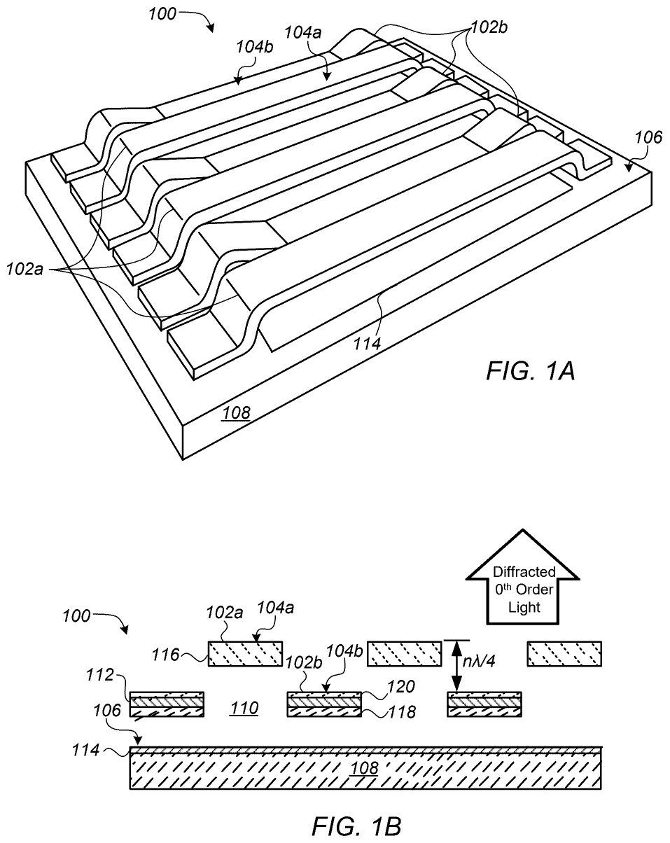

FIGS. 1A and 1B illustrate a portion of a MEMS based linear array, known as a flat grating light valve or flat GLV™, and commercially available from Silicon Light Machines, in San Jose, California. By flat it is meant that the GLV™includes a large number of closely spaced alternating active and stationary active ribbons, each having a reflective top surface, and thus providing the SLM with flat surface.

Referring to FIGS. 1A and 1B, a flat GLV™ 100 generally includes a number of ribbons 102a, 102b; each having a light reflective surface 104a, 104b, supported over a surface 106 of a substrate 108. The number of ribbons include a number of stationary or static bias ribbons 102a interlaced with electrostatically displaceable active ribbons 102b deflectable through a cavity or gap 110 toward the substrate 108 to form an addressable diffraction grating with adjustable diffraction strength. The active ribbons 102b are deflected towards the surface 106 of the substrate 108 by electrostatic forces generated when a voltage is applied between ribbon electrodes 112 in the active ribbons 102b and a base or substrate electrode 114 formed in or on the surface of the substrate 108.

FIG. 1B shows a schematic sectional side view of the flat GLV™ 100 of FIG. 1A. Referring to FIG. 1B, each stationary ribbon 102a includes a mechanical layer 116 on or from which the reflective surface 104a is formed. Each active ribbon 102b includes a tensile or elastic mechanical layer 118 to support the active ribbon above the surface 106 of the substrate 108, a conducting layer forming a ribbon electrode 112 and a top reflective layer 120 on or from which the reflective surface 104b is formed.

Referring again to FIG. 1B, light from a narrow band or single frequency light source is projected or imaged onto the flat GLV™ so that light reflected from the stationary ribbons 102a adds as vectors of magnitude and phase with that reflected from the displaced active ribbons 102b, thereby modulating light reflected from the flat GLV™ 100. When the reflective surface 104b is displaced from the reflective surface 104a of an adjacent stationary ribbon 102a by a distance equal to an odd multiple (n) of a quarter wavelength (λ) of the incident light, nλ/4 where in is an odd integer, light from the ribbons 102a, 102b, is fully diffracted or extinguished.

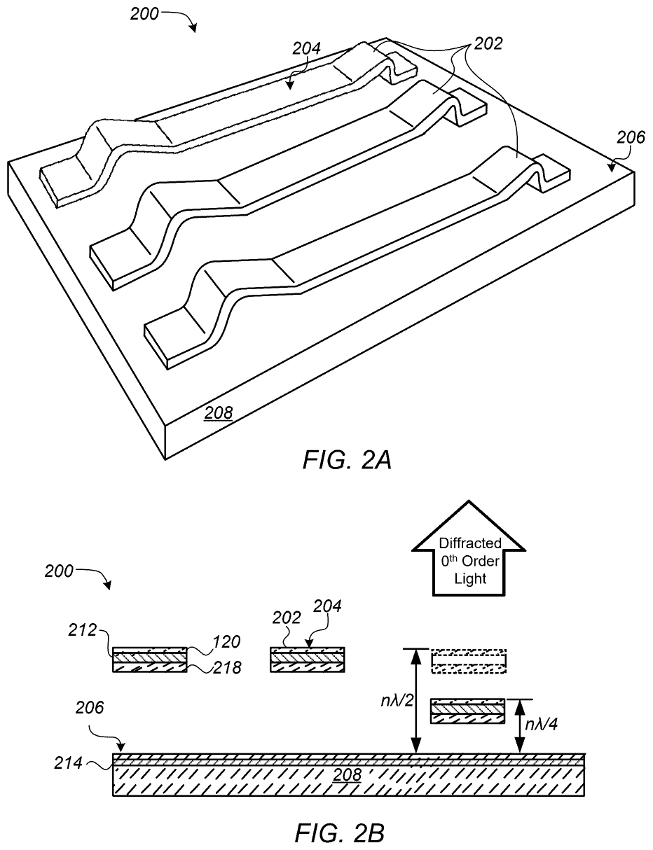

FIGS. 2A and 2B illustrate a portion of another embodiment of a MEMS based linear array, known as a ‘true’ Grating or Grated Light Valve (GLV™) commercially available from Silicon Light Machines, Inc., of San Jose, California. By true GLV™ it is meant a MEMS-based linear array including multiple movable or active ribbons suspended over a reflective surface of or on a substrate, each having a reflective surface thereon, and each separated from at least one adjacent active ribbon by a distance equal to a width of each of the plurality of active ribbons, without stationary or static bias ribbons there between. Generally or preferably, the reflective surfaces on the active ribbons and the reflective surfaces on the substrate exposed between adjacent active ribbons are sized and shaped to define substantially equal areas so that 0^{th}-order light reflected from the active ribbons and the adjacent areas of reflective surface of the substrate there between can be modulated or attenuated from fully reflected to fully diffracted or extinguished.

Referring to FIGS. 2A and 2B, the GLV™ 200 generally includes a dynamically adjustable diffraction grating formed by multiple, electrostatically displaceable or active ribbons 202, each having a light reflective surface 204 and supported over a surface of a substrate 208 having a number of reflective surfaces 206 formed thereon. Each of the active ribbons 202 is separated from at least one adjacent active ribbon by a distance equal to a width of each of the plurality of active ribbons, without any stationary or static bias ribbons there between. The reflective surfaces 204 on the active ribbons 202 and the reflective surfaces 206 on the substrate exposed between adjacent active ribbons are sized and shaped to define substantially equal areas so that 0^{th}-order light reflected from the active ribbons and the adjacent areas of reflective surface of the substrate there between can be modulated or attenuated from fully reflected to fully diffracted or extinguished.

FIG. 2B shows a schematic sectional side view of the GLV™ 200 of FIG. 2A. Referring to FIG. 1B, each active ribbon 202 includes a tensile or elastic mechanical layer 218 to support the active ribbon above the surface 206 of the substrate 208, a conducting layer forming a ribbon electrode 212 and a top reflective layer on or from which the reflective surface 204 is formed. A base or substrate electrode 214 is formed in or on the surface of the substrate 208.

Referring again to FIG. 2B, light from a narrow band or single frequency light source is projected or imaged onto the GLV™ 200 so that light reflected from the active ribbons 202 adds as vectors of magnitude and phase with that reflected from the surface 206 of the substrate 208, thereby modulating light reflected from the GLV. When the reflective surface 204 of the active ribbons 202 is displaced from the reflective surface 206 of the substrate 208 by a distance equal to an odd multiple (n) of a quarter wavelength (λ) of the incident light, nλ/4 where in is an odd integer, light from the ribbons 102a, 102b, is fully diffracted or extinguished.

The range of wavelengths of incident light that a MEMS-based linear array can modulate from fully reflective to fully extinguished is determined by the maximum distance by which an active ribbon can be displaced. This maximum distance is determined and limited by physical dimensions characteristics of the ribbon, including length, thickness, elasticity, a gap between a central portion of the ribbon and the surface of the substrate, and the electrostatic force that can be applied between the ribbon electrode and substrate electrode. Thus, multiple MEMS-based linear arrays in a monolithic SLM, each receiving a different, non-overlapping range of wavelengths or specific wavelengths can be operated to concurrently modulate all received wavelengths, with full grey scale modulation by mechanically or dimensionally tuning active ribbons in each linear array

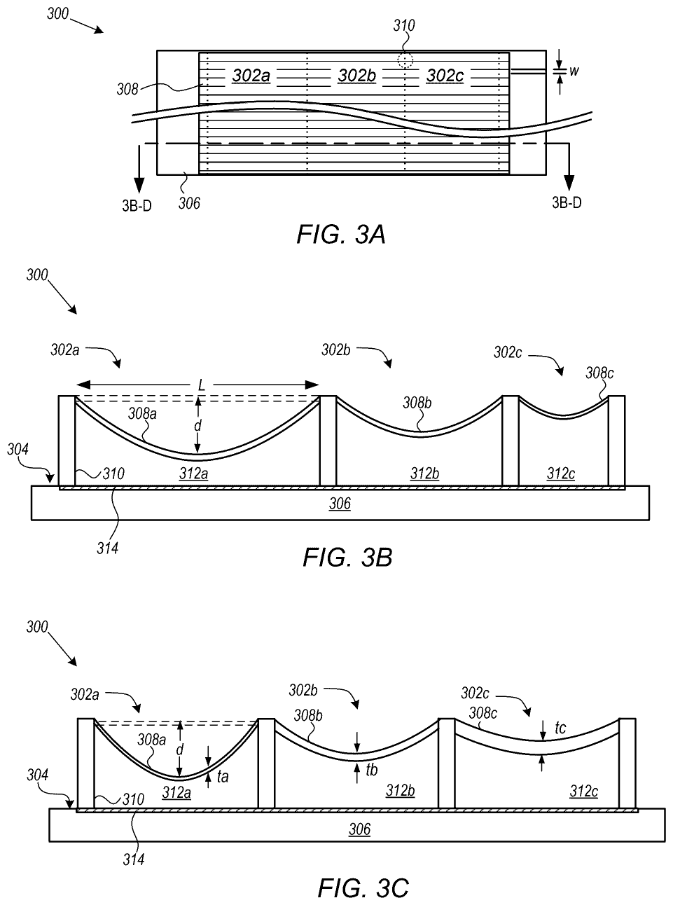

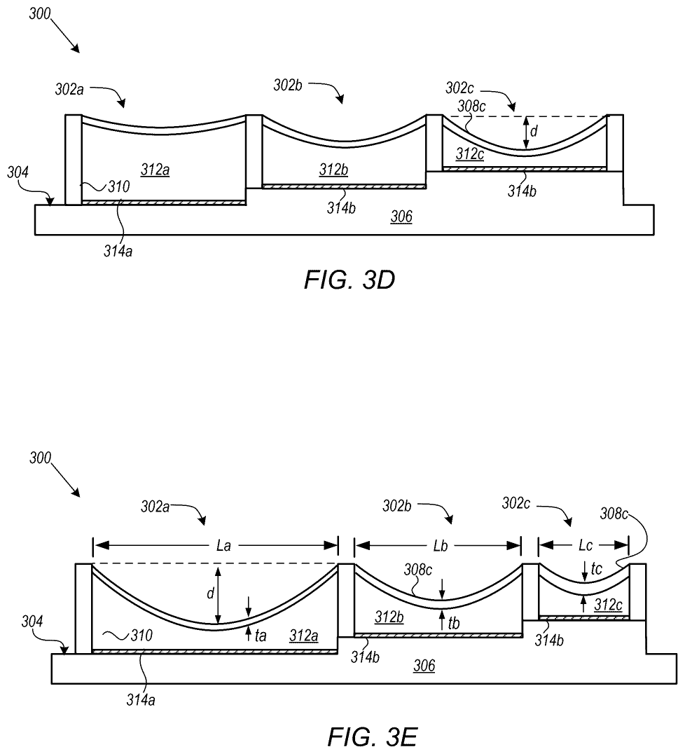

Different ways or methods of dimensionally tuning multiple MEMS-based linear arrays in a single, monolithic SLM are shown in FIGS. 3A to 3E. FIG. 3A is a top view of three abutting MEMS-based linear arrays 302a, 302b, 302c, on a surface 304 of a substrate 306. Each linear array 302a, 302b, 302c, includes a multiple ribbons 308, including a number of electrostatically displaceable ribbons, supported by posts 310 over the surface of the substrate. FIGS. 3B to 3E are schematic block diagrams of a sectional side view of active ribbons in three abutting MEMS-based linear array illustrating embodiments for mechanically or dimensionally tuning each of the linear arrays to modulate a different, non-overlapping range of wavelengths.

Referring to FIG. 3B, in a first embodiment, active ribbons 308a, 308b, 308c, in each linear arrays 302a, 302b, 302c are made from the same material, have substantially the same thickness (t), width (w) and gaps 312a, 312b, 312c, between lower surfaces of the active ribbons and the surface 304 of the substrate 306, and driven by the same drive voltage between ribbon electrodes (not shown) and a substrate electrode 314. As illustrated in FIG. 3B displacement (d) of the active ribbons 308a, 308b, 308c, increases as the length (l) of the active ribbon increases, with the longest active ribbon 308a exhibiting the greatest displacement, and the shortest active ribbon 308c the least. The increase in displacement is caused by an increase in area of the ribbon electrode as well as decreasing elastic restoring force with increasing ribbon length.

In a second embodiment, shown in FIG. 3C, the active ribbons 308a, 308b, 308c, in each linear array 302a, 302b, 302c are made from the same material, have substantially the same length (L), width (w) and gaps 312a, 312b, 312c, and driven by the same drive voltage, but have different thicknesses (t). As illustrated in FIG. 3C displacement (d) of the active ribbons 308a, 308b, 308c, decreases as the thickness (t) of the active ribbon increases, with the thinnest active ribbon 308a exhibiting the greatest displacement (d), and the thickest active ribbon 308c the least. The increase in displacement is caused by an increase in flexibility or elasticity of the thinner ribbon 308a. In the embodiment shown the thicknesses of the active ribbons increases from left to right, with ta<tb<tc.

In another embodiment, shown in FIG. 3D, the surface 304 of the substrate 306 is structured, having a stepped cross-sectional profile so that the gap 312a, 312b, 312c, underlying each linear array 302a, 302b, 302c, decreases for each array, with a consequent increase in the electrostatic force between ribbon electrodes and the substrate electrodes 314a, 314b, 314c, and with a proportional increase in displacement. Active ribbons 308a, 308b, 308c, in each linear array 302a, 302b, 302c are made from the same material, have substantially the same length (l), width (w) and thickness (t). It is noted that substrate electrodes 314a, 314b, 314c, underlying each 302a, 302b, 302c, can be physically and electrically separate and coupled to a different voltage. In the embodiment illustrated, it is assumed the substrate electrodes 314a, 314b, 314c, are not electrically separate or are coupled to the same voltage. Referring to FIG. 3D, it is seen that active ribbon 308a has the largest or greatest gap 312a, and exhibits the least displacement (d), and active ribbon 308c with the smallest gap 312c exhibiting the greatest displacement due to the greater electrostatic force generated by the ribbon electrode and substrate electrode 314. The increase in electrostatic force is caused by a decrease in distance separating the electrode and substrate electrode 314a. However, the increased gap allows for longer total displacement and therefore may accommodate longer wavelengths. For a true GLV™, the ideal gap will be determined by a desired optical response, generally with the gap as an even or odd multiple of a targeted wavelength to correspond to a quiescent bright or dark state, respectively.

In another embodiment, shown in FIG. 3E, all three of the above ways of dimensional tuning are used in tuning the MEMS-based multiple linear arrays 302a, 302b, 302c. That is the surface 304 of the substrate 306 is structured so that the gaps 312a, 312b, 312c, underlying each linear array 302a, 302b, 302c, are different, and the lengths La, Lb, Lc, and thicknesses ta, tb, tc, of the active ribbons 304a, 304b, 304c, in each of each linear array are different. In one embodiment, such as that shown, the thicknesses of the active ribbons 304a, 304b, 304c, increases from left to right, with ta<tb<tc, and the lengths of the active ribbons decreases from left to right, with La>Lb>Lc, while the gaps 312a, 312b, 312c, also decrease. Thus, the linear array selected to receive the shortest wavelengths, e.g., linear array 302c, will have the smallest gap 312c and thicker and/or shorter ribbon length, while the linear array selected to receive the longest wavelengths, e.g., linear array 302a, will have the largest gap 312a and the thinnest and/or longest ribbon length. Since a minimum gap of a fully deflected active ribbon is determined or defined by a desired optical response, either quiescent (off-state) dark or bright, once the gap 312a, 312b, 312c, has been determined, the length and thickness of the active ribbons in each linear array can then be adjusted to achieve the same intensity versus voltage (IV) response for each in linear array 302a, 302b, 302c, in the monolithic SLM 300 over the same voltage swing.

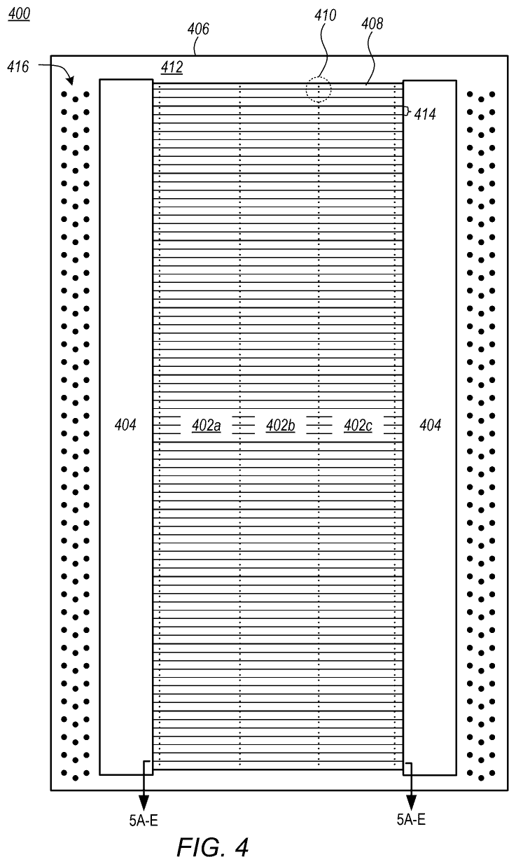

FIG. 4 is a schematic block diagram of a monolithic spatial light modulator (SLM 400) including multiple MEMS-based linear arrays 402a, 402b, 402c, and a drive circuit 404 on a single substrate 406. Each linear array 402a, 402b, 402c, includes a multiple, light reflective ribbons 408, including a number of electrostatically displaceable, active ribbons, supported by posts 410 over a surface 412 of the substrate 406. The linear arrays 402a, 402b, 402c, can be flat GLVs™, as shown and described above with reference to FIGS. 1A and 1B. In this embodiment, the linear arrays 402a, 402b, 402c, include a large number of closely spaced alternating electrostatically displaceable, active ribbons and static ribbons, each ribbon having a reflective top surface, and one or more active and static ribbons grouped to form a number of pixels 414 in each array.

Alternatively, the linear arrays 402a, 402b, 402c, can be true grating light valves or GLVs™, as shown and described above with reference to FIGS. 2A and 2B. In this embodiment, the linear arrays 402a, 402b, 402c, include a large number of spaced apart electrostatically displaceable, active ribbons 408 separated by open spaces exposing a reflective surface on the surface 412 of the substrate 406. One or more active are grouped together with the exposed reflective surface on the surface 412 of the substrate 406 form a number of pixels 414 in each array.

Referring to FIG. 4, the drive circuit 404 is integrally fabricated in the substrate 406 using, for example, standard complementary metal-oxide-semiconductor (CMOS) techniques. Generally, as shown, the drive circuit 404 is formed in the substrate 406 laterally adjacent to the linear arrays 402a, 402b, 402c, before fabrication of the linear arrays, and is electrically coupled to substrate electrodes and ribbon electrodes in the linear arrays through a number of electrical connections, such as vias and interlevel metal layers. Alternatively, the drive circuit 404 can formed at least partially underlying the linear arrays 402a, 402b, 402c. The linear arrays 402a, 402b, 402c, and drive circuit 404 are further electrically coupled to an external controller, power supply or other components in a system in which the SLM 400 is used, through a number of solder bumps 416 or a ball-grid-array (not shown) on a backside of the substrate 406.

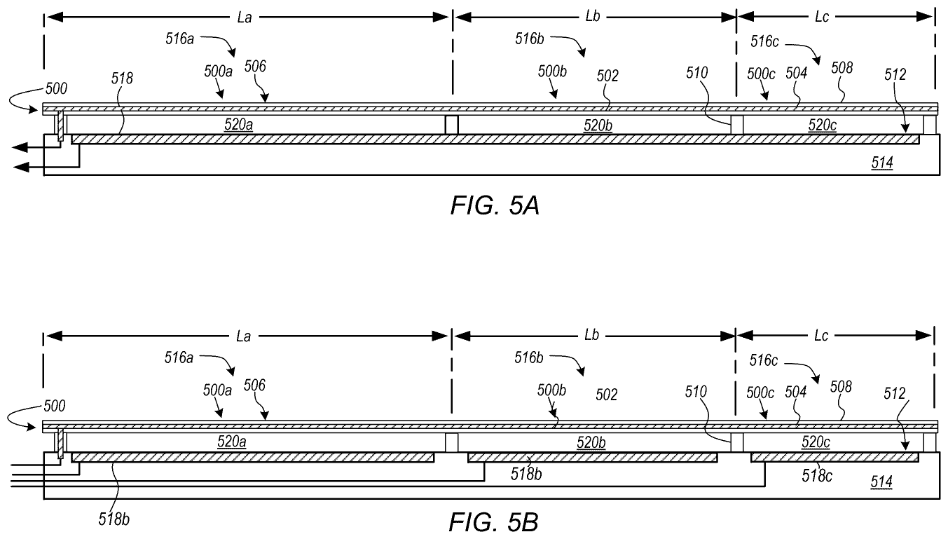

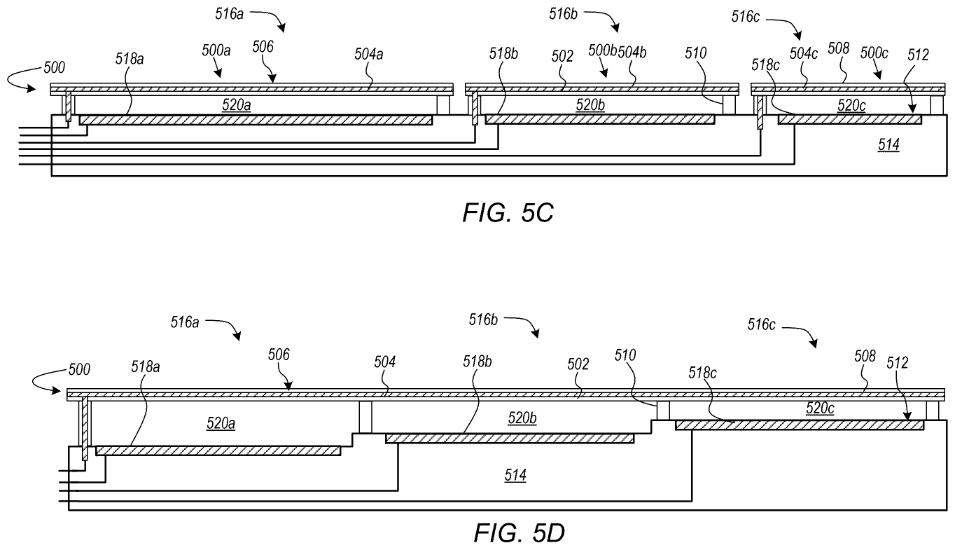

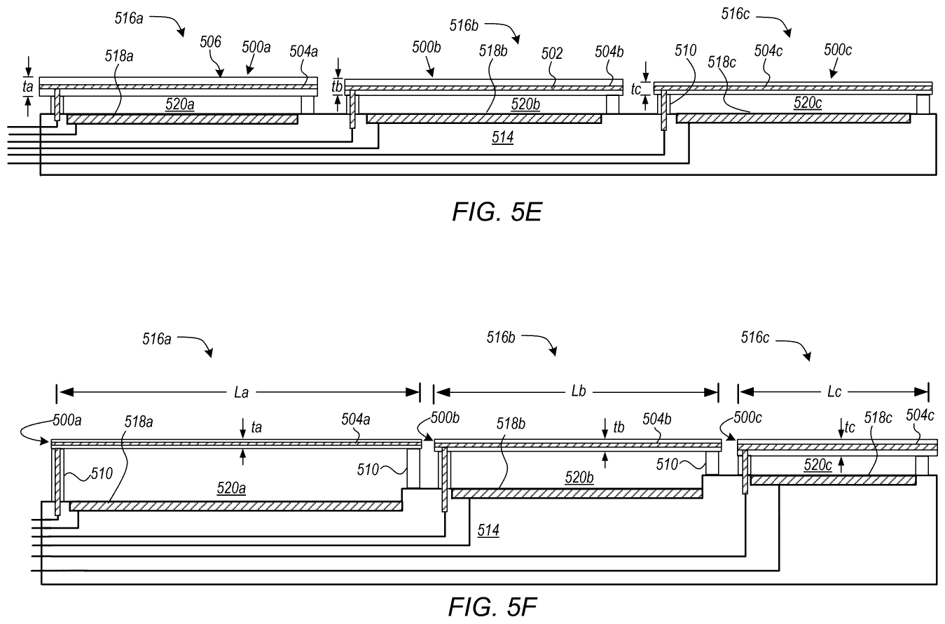

FIGS. 5A to 5F are schematic block diagrams of a sectional side view of active ribbons in FIG. 4 illustrating embodiments for dimensionally and electrically tuning each of the linear arrays to modulate a different, non-overlapping range of wavelengths. Generally, the electrostatically displaceable, active ribbon 500 includes an elastic mechanical layer 502, a ribbon electrode or ribbon electrode 504 and a reflective surface 506 overlying the mechanical layer and ribbon electrode. In certain embodiments, such as that shown, the reflective surface 506 can be formed on or from a separate reflective layer 508, discrete from and overlying the ribbon electrode 504. In other embodiments, not shown, the reflective surface 506 can be formed on or from the ribbon electrode 504.

The active ribbon 500 is supported above a surface 512 of a substrate 514 by a number of posts 510, and, in accordance with the present invention to divide the active ribbon along a long axis thereof to form separate active ribbons 500a, 500b, 500c, in multiple MEMS based linear arrays, shown here as three linear arrays 516a, 516b, 516c. The posts 510 are typically made of a dielectric material such as silicon-nitride (Si₃N₄) or silicon-germanium (SiGe).

Generally, the mechanical layer 502 includes a taut layer of silicon-nitride film (Si₃N₄) or silicon-germanium (SiGe) flexibly supported by the posts 510 above the surface 512 of the substrate 514. The ribbon electrode 504 is formed over and in direct physical contact with the mechanical layer 502 and can include any suitable conducting or semiconducting material compatible with standard MEMS fabrication technologies. For example, the ribbon electrode 504 can include an amorphous or polycrystalline silicon (poly) layer, a silicon-germanium (SiGe) layer, or, if the reflective surface 506 is formed on or from the ribbon electrode, the conductive layer could also be metallic.

The separate, discrete reflecting layer 508, where included, can include any suitable metallic, dielectric or semiconducting material compatible with standard MEMS fabrication technologies, and capable of being patterned using standard lithography and etching techniques to form the reflective surface 506.

In operation the ribbon 500 is deflected towards the surface 512 of the substrate 514 by electrostatic forces generated when a voltage is applied between the ribbon electrode 504 and a substrate electrode 518 formed in or on the substrate. The applied voltages are provided by a drive circuit (not shown) by applying a time varying voltage signal to the ribbon electrode 504 of one or more of the ribbons in an array while a fixed voltage or potential is applied to the substrate electrode 518.

In the embodiment shown in FIG. 5A, a single contiguous ribbon 500 is functionally divided by the posts to form the separate, active ribbons 500a, 500b, 500c, of deceasing length (l) in each of the three linear arrays 516a, 516b, 516c. The active ribbon 500a with the longest or greatest length exhibits the largest or greatest displacement when electrostatically displaced and the shortest active ribbon 500c the least. The increase in displacement is caused by the larger area of the ribbon electrode 504 overlying the substrate electrode 518 in the first linear array 516a. By adjusting the length of each active ribbon 500a, 500b, 500c, a maximum displacement of each active ribbon altered, and each MEMS-based linear array 516a, 516b, 516c, is dimensionally and electrically tuned to modulate a different, non-overlapping range of wavelengths or a specific wavelength. For example, the first linear array 516a having the longest ribbon 500a can be tuned to modulate wavelengths of from 620 to 750 nanometers (nm) corresponding to red light in the visible spectrum, the second linear array 516b can be tuned to modulate wavelengths of from 495 to 570 nm corresponding to green light in the visible spectrum, and the third linear array 516c can be tuned to modulate wavelengths of from 405 to 495 nm corresponding to violet-blue light in the visible spectrum.

By dimensionally tuned it is meant that physical dimensions of active ribbons in a pixel in a MEMS-based linear array, such ribbon length, width, thickness and a gap separating a lower surface of the ribbon from an upper surface of a substrate on which it is formed are selected to provide a full gray scale modulation of light at a specific wavelength or range of wavelengths reflected from the pixel, from fully reflecting (light) to fully diffracting (dark) when driven by a drive voltage in the SLM. By electrically tuned it is meant each pixel in each MEMS-based linear array is driven by a drive channel tuned for an optimal intensity vs voltage (IV) response for the specific wavelength or range of wavelengths.

In the embodiment shown in FIG. 5A, the substrate electrode 518 is a single, substantially uniform and continuous electrode extending underneath the active ribbons 500a, 500b, 500c, of all of the three linear arrays 516a, 516b, 516c. In another embodiment, shown in FIG. 5B, the three linear arrays 516a, 516b, 516c can include three separate substrate electrodes 518a, 518b, 518c, each underlying one of the three linear arrays to enable each MEMS-based linear array to be dimensionally and electrically tuned to modulate a different, non-overlapping range of wavelengths or a specific wavelength.

In yet another embodiment, shown in FIG. 5C, the contiguous ribbon 500 can be physically and electrically divided to form the separate, active ribbons 500a, 500b, 500c, each including separate ribbon electrodes 504a, 504b, 504c, in each of the three linear arrays 516a, 516b, 516c, to enable additional or more precise control of the electrically tuning of each of the MEMS-based linear arrays.

In another embodiment, shown in FIG. 5D, the surface 512 of the substrate 514 is structured, having a stepped cross-sectional profile so that gaps 520a, 520b, 520c, underlying each linear array 516a, 516b, 516c, decreases, resulting in a decrease between the ribbon electrodes 504a, 504b, 504c, and substrate electrodes 518a, 518b, 518c, resulting in an increase in the electrostatic force and a proportional increase in displacement. Referring to FIG. 5D, it is seen that active ribbon 500A has the largest or greatest gap 520a, and exhibits the least displacement (d), and active ribbon 500c with the smallest gap 520c exhibiting the greatest displacement. In the embodiment illustrated, the substrate electrodes 518a, 518b, 518c, and the ribbon electrodes 504a, 504b, 504c, are physically and electrically separate, and can be independently driven at different voltages to further electrically tune the linear arrays 516a, 516b, 516c. However, it will be understood that either the substrate electrodes 518a, 518b, 518c, the ribbon electrodes 504a, 504b, 504c, or both, can be electrically connected or coupled to the same voltage.

FIG. 5E illustrates another architecture for dimensionally tuning each of the linear arrays 516a, 516b, 516c. In the embodiment shown the active ribbons 500a, 500b, 500c, in each linear array 516a, 516b, 516c, are made from the same material, have substantially the same length (l), width (w) and gaps 520a, 520b, 520c, but have different thicknesses (t). As illustrated in FIG. 5E displacement (d) of the active ribbons 500a, 500b, 500c, decreases as the thickness (t) of the active ribbon increases. Thus, active ribbon 500a having the greatest thickness (t1) will have the least displacement (d), while active ribbon 500c having the least thickness (t3) will have the greatest displacement (d), and the active ribbon 500b having an thickness (t2) between t1 and t2 (t1>t2>t3), will have an intermediate displacement (d). The decrease in displacement is caused by a decrease in flexibility or elasticity of the thicker ribbon 500c.

In another embodiment, shown in FIG. 5F, all three of the above ways of dimensional tuning are used in tuning the MEMS-based multiple linear arrays 516a, 516b, 516c. That is the surface 512 of the substrate 514 is structured so that the gaps 520a, 520b, 520c, underlying each linear array 516a, 516b, 516c, are different, and the lengths La, Lb, Lc, and thicknesses ta, tb, tc, of the active ribbons 500a, 500b, 500c, in each of each linear array are different. In one embodiment, such as that shown, the thicknesses of the active ribbons 500a, 500b, 500c, increases from left to right, with ta<tb<tc, and the lengths of the active ribbons decreases from left to right, with La>Lb>Lc, while the gaps 520a, 520b, 520c, also decrease. Thus, the linear array selected to receive the shortest wavelengths, e.g., linear array 516c, will have the smallest gap 520c and thicker and/or shorter ribbon length, while the linear array selected to receive the longest wavelengths, e.g., linear array 516a, will have the largest gap 520a and the thinnest and/or longest ribbon length. Since a minimum gap of a fully deflected active ribbon is determined or defined by a desired optical response, either quiescent (off-state) dark or bright, once the gap 520a, 520b, 520c, has been determined, the length and thickness of the active ribbons in each linear array can then be adjusted to achieve the same intensity versus voltage (IV) response for each in linear array 516a, 516b, 516c, in the monolithic SLM 400 over the same voltage swing.

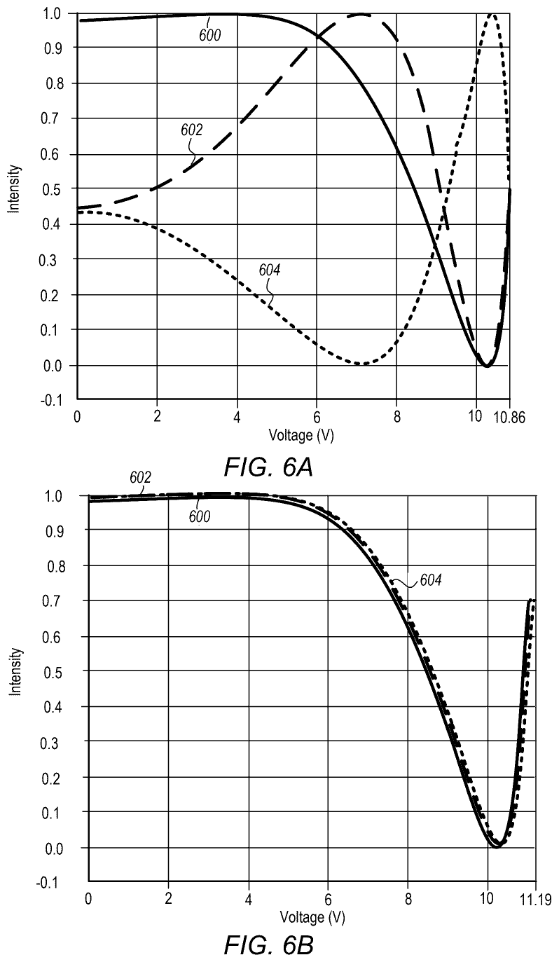

FIGS. 6A and 6B are graphs of intensity versus voltage (IV) for three MEMS-based linear arrays modulating different, non-overlapping range of wavelengths and illustrating the IV response for untuned versus mechanically or dimensionally tuned arrays. FIG. 6A illustrates a normalized intensity from 1 (fully reflective) to 0 (fully diffractive) for three MEMS-based linear arrays, having substantially the same length (l), width (w) thicknesses (t) of active ribbons, and gaps, driven by the same drive voltage, but illuminated with different wavelengths of incident light and exhibiting substantially different IV responses. In particular, line 600 represents light having wavelengths of from 620 to 750 nm corresponding to red light in the visible spectrum, line 602 represents light having wavelengths of from 495 to 570 nm corresponding to green light, and line 604 represents light having wavelengths of from 405 to 495 nm corresponding to violet-blue light.

FIG. 6B illustrates a normalized intensity from 1 (fully reflective) to 0 (fully diffractive) for three dimensionally tuned MEMS-based linear arrays driven by the same drive voltage, each illuminated with the same red, green or violet-blue light as in FIG. 6A. As seen in FIG. 6B the IV responses exhibited for each of the three dimensionally tuned MEMS-based linear arrays illuminated with the different, non-overlapping range of wavelengths is substantially the same. Thus, it is seen that a monolithic SLM including three dimensionally tuned MEMS-based linear arrays can concurrently modulate light in the three different, non-overlapping ranges of wavelengths with the same drive voltage, without deleteriously attenuating one or more of the different wavelengths or colors.

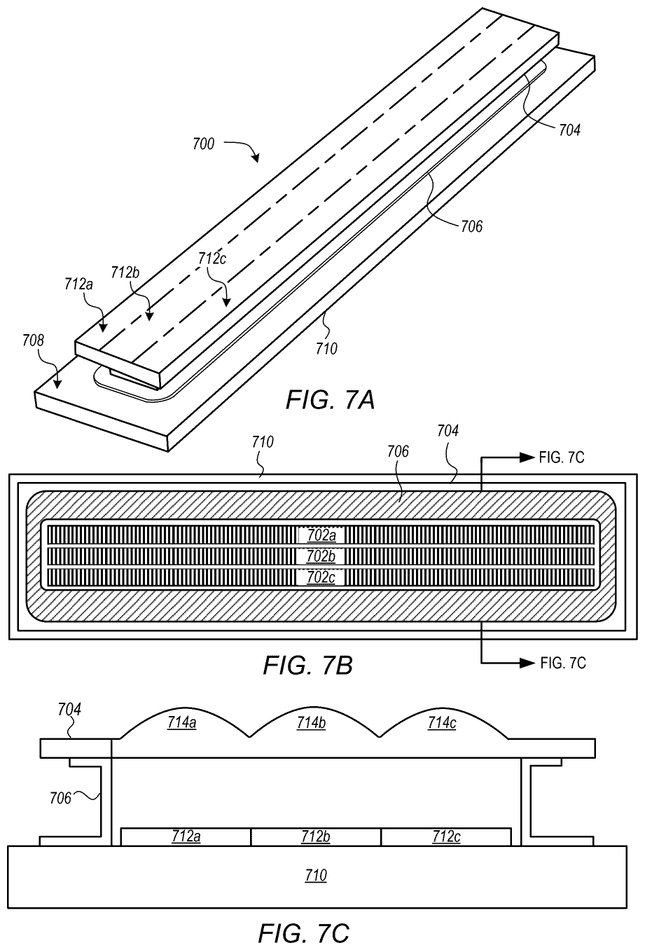

As illustrated in FIGS. 7A to 7C the monolithic SLM 400 of FIG. 4 including multiple MEMS-based linear arrays 702a, 702b, 702c, can be enclosed in a wafer level package 700 having a transparent window or cover 704 through which incident and reflected light can be passed while protecting the arrays from environmental contamination during manufacture and operation.

FIG. 7A is a perspective view of one embodiment of the wafer level package 700. Generally, the package 700 includes in addition to the cover 704, a rectangular spacer 706 that surrounds the linear arrays 702a, 702b, 702c. The spacer 706 is made from a metallic, ceramic or other dielectric material, and is soldered or otherwise hermetically sealed to a surface 708 of a substrate 710 on which the linear arrays 702a, 702b, 702c, are formed, and to the cover 704. The volume enclosed by the hermetically sealed package can be evacuated, or filled with a gas mixture selected to minimize aging or decomposition of elements of the linear arrays 702a, 702b, 702c, and/to enhance heat transfer away from the linear arrays and out to the package 700 or substrate. The gas mixture can be pressurized or non-pressurized relative to atmospheric pressure.

In some embodiments, the cover 704 can include one or more optical filter layers 712a, 712b, 712c, such as an anti-reflective (AR) coatings, overlying one or more the of linear arrays 702a, 702b, 702c, the optical filter layers having thicknesses or made from a material operable to filter light incident on or reflected by each individual linear array. The optical filter layers 712a, 712b, 712c, can be formed by depositing one or more thin optically transparent layers of silicon nitride (SiNx), silicon oxide (SiOx) and/or titanium dioxide (TiO2), on the cover 704.

FIG. 7C is a schematic block diagram of a sectional side view of the wafer level package 700 illustrating another embodiment of the cover 704, in which the cover 704 is structured to include a number of cylindrical lenses 714a, 714b, 714c, one over each of the multiple MEMS-based linear arrays 702a, 702b, 702c, to focus light from a light source incident on the cylindrical lens into a line to substantially fill a linear array underlying the lens.

In some embodiments, the active ribbons in the multiple MEMS-based linear arrays include openings or aperture therein that enable each ribbon to function as a single pixel, greatly increasing a resolution of the monolithic MEMS including the linear arrays.

The resolution of an optical system using a SLM with MEMS-based linear arrays is limited by the size of a pixel, which in turn is determined by the size and number of individual diffractors or ribbons in a single pixel. Generally, SLMs, such as the flat GLV™ requires a minimum of two ribbons (one static and one active) per pixel. Similarly, each pixel in a true grating light valve or (GLV™) requires at least one active ribbon, and a ribbon width of the static, reflective surface on the substrate underlying the GLV™. However in practice two or three line-pairs, that is multiple pairs of active-static ribbon or ribbon-gap, are needed per pixel to achieve higher contrast. One technique for increasing resolution is to provide openings or apertures in each active ribbon that exposes an underlying light reflective surface. Thus a single ribbon may act as two or three ribbon-gap line-pairs within the patterned area. Generally, when the total area of the openings in an active ribbon is substantially equal to the illuminated area of the active ribbon, the active ribbon can function as a single pixel. However, as the line-pair feature approaches the order of the wavelength of the illuminating light, this duty cycle may be adjusted to compensate for under ribbon coupling of the highly diffracted light.

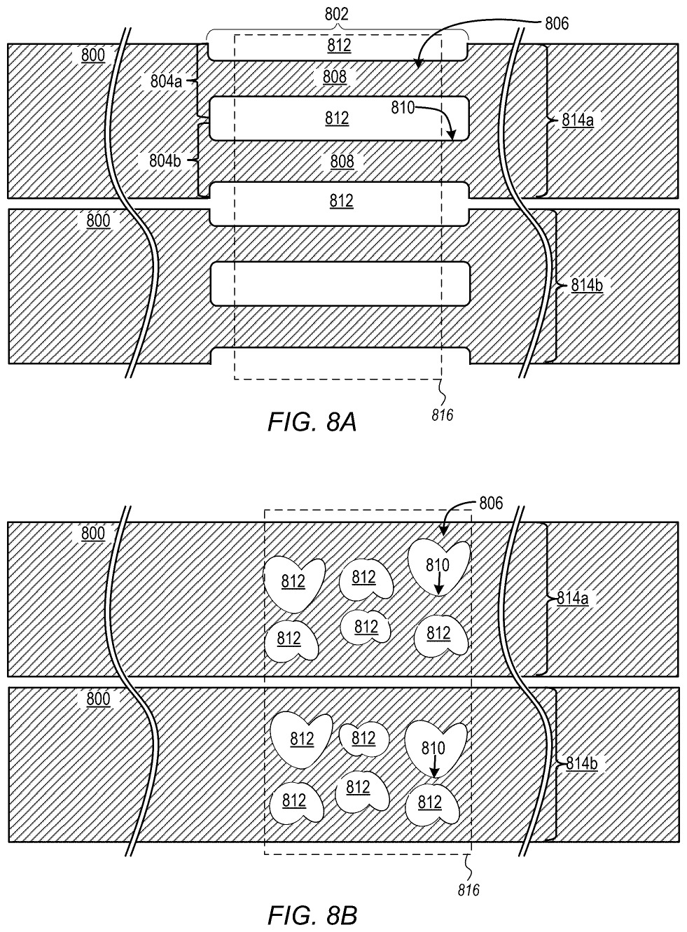

In one embodiment, shown in FIG. 8A, the active ribbons in the MEMS-based linear arrays include slotted or split-ribbon design that enables a single ribbon pixel resulting in a monolithic SLM having greater resolution and higher contrast. FIG. 8A is a top view of two active ribbons or pixels 814a, 814b, in a MEMS-based linear array with split ribbons having two diffractors or ribbon-pairs per active-ribbon or pixel to decrease pixel size and pitch to provide high contrast amplitude modulation. Referring to FIG. 8A, each active-ribbon 800 has a split-ribbon portion 802 including multiple diffractors 804a and 804b, each diffractor including an active light reflective surface 806 on a linear segment 808 of the split-ribbon portion and at least one opening 810 adjacent to the linear segment through which a static light reflective surface 812 below the active ribbon is exposed. Moving the movable ribbon brings light reflected from the first, reflective surface on the active ribbon into constructive or destructive interference with light reflected from the second, static reflective surface on the substrate, thereby enabling amplitude modulation of the light. By providing openings 810 in the active ribbon 800 having a total area substantially equal to the illuminated area 816 of the active ribbon or adjusted for under ribbon coupling as previously discussed, the active ribbons can function as a single pixel 814a, 814b.

In another embodiment, shown in FIG. 8B each of the active ribbons 800 in a MEMS-based linear array has a number of irregularly shaped and sized openings 810 extending through the thickness of the active ribbon to enable light to pass through to reflect from a static light reflective surface 812 on a surface of the substrate below the active ribbon. By providing openings 810 in the active ribbon 800 having a total area substantially equal to the illuminated area 816 of the active ribbon or adjusted for under ribbon coupling as previously discussed, the active ribbons can function as a single pixel.

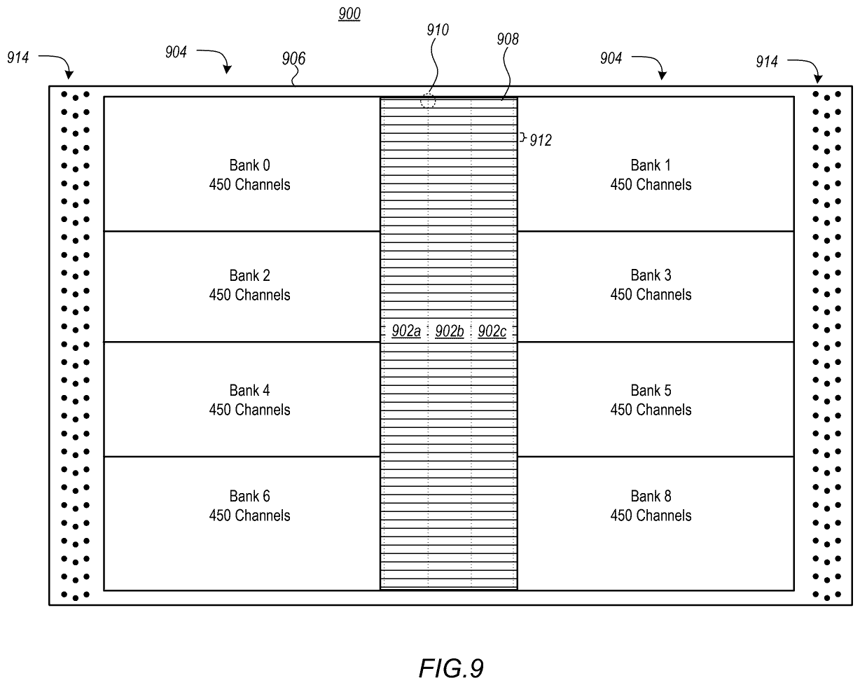

FIG. 9 is a schematic block diagram of an exemplary architecture for a monolithic SLM 900 including three MEMS-based linear arrays 902a, 902b, 902c, of 1200 pixels each, and a drive circuit 904 integrally fabricated in the substrate 906 adjacent to the MEMS-based linear arrays. Each MEMS-based linear arrays 902a, 902b, 902c, is dimensionally and electrically tuned to modulate a different, non-overlapping range of wavelengths or a specific wavelength.

Referring to FIG. 9 each linear array 902a, 902b, 902c, includes a multiple, light reflective ribbons 908, including a number of electrostatically displaceable, active ribbons, supported by posts 910 over a surface of the substrate 906. The linear arrays 902a, 902b, 902c, can be flat GLVs™, as shown and described above with reference to FIGS. 1A and 1B. In this embodiment, the linear arrays 902a, 902b, 902c, include a large number of closely spaced alternating electrostatically displaceable, active ribbons and static ribbons, each ribbon having a reflective top surface, and one or more active and static ribbons grouped to form 1200 pixels 912 in each array.

Alternatively, the linear arrays 902a, 902b, 902c, can be true grating light valves or GLVs™, as shown and described above with reference to FIGS. 2A and 2B. In this embodiment, the linear arrays 902a, 902b, 902c, include a large number of spaced apart electrostatically displaceable, active ribbons 908 separated by open spaces exposing a reflective surface on the surface of the substrate 906. One or more active are grouped together with the exposed reflective surface on the surface of the substrate 906 form a number of pixels 912 in each array.

Referring to FIG. 9, in the embodiment shown the drive circuit 904 has a multiple drive circuit architecture with 3600 total drive channels in eight banks of 450 drive channels each, each drive channel operable to drive one or more active ribbons in one pixel 912 in one linear array. Generally, as shown, the drive circuit 904 is formed in the substrate 906 laterally adjacent to the linear arrays 902a, 902b, 902c, before fabrication of the linear arrays, and is electrically coupled to substrate electrodes and ribbon electrodes in the linear arrays through a number of electrical connections, such as vias and interlevel metal layers. Alternatively, the drive circuit 904 can be formed at least partially underlying the linear arrays 902a, 902b, 902c. The linear arrays 902a, 902b, 902c, and drive circuit 904 are further electrically coupled to an external controller, power supply or other components in a system in which the monolithic SLM 900 is used, through a number of solder bumps 914 or a ball-grid-array (not shown) on a backside of the substrate 906.

In one embodiment, each MEMS-based linear array 902a, 902b, 902c, is mechanically or dimensionally tuned to modulate a different, non-overlapping range of wavelengths or a specific wavelength in the visible spectrum. For example, the first linear array 902a can be tuned to modulate wavelengths of from 620 to 750 nm corresponding to red light in the visible spectrum, the second linear array 902b can be tuned to modulate wavelengths of from 495 to 570 nm corresponding to green light in the visible spectrum, and the third linear array 902c can be tuned to modulate wavelengths of from 405 to 495 nm corresponding to violet-blue light in the visible spectrum.

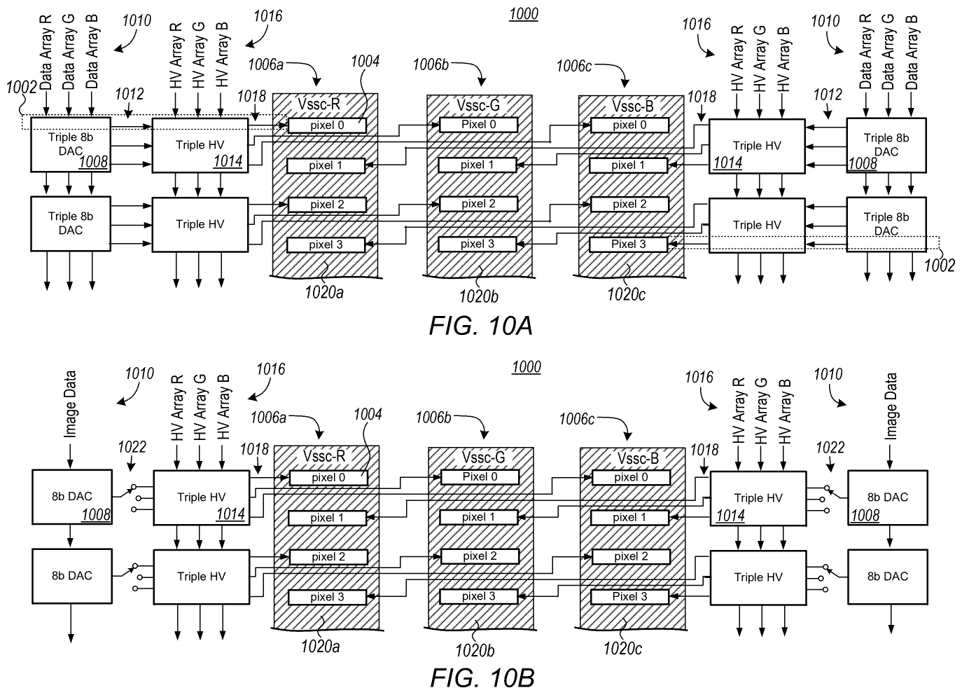

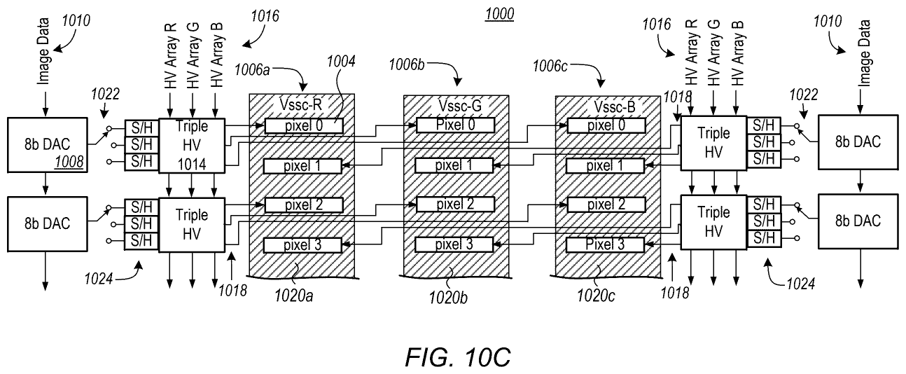

FIGS. 10A to 10C are schematic block diagrams of different embodiments of a drive circuit having a multiple or multi-driver architecture for use in the monolithic SLM 900 of FIG. 9.

FIG. 10A illustrates an embodiment of a drive circuit 1000 having multi-driver architecture in which each channel or driver 1002 drives a single pixel 1004 in a single one of the three MEMS-based linear arrays 1006a, 1006b, 1006c, and has a unique digital-to-analog transfer function tuned for an optimal intensity versus voltage (IV) response adapted for the wavelength or range of wavelengths to be modulate by the linear array. Referring to FIG. 10A, the drive circuit 1000 includes multiple, triple digital-to-analog converters (DACs 1008), operable to receive digital image data 1010 for each of the three MEMS-based linear arrays 1006a, 1006b, 1006c, from a system processor or controller (not shown) and to couple three analog voltage signals 1012 to multiple triple high-voltage (HV) output drivers 1014.

In the embodiment shown the triple DACs 1014 include three 8-bit DACs, each operable to receive 8-bit digital imaging data 1010 from a system processor or controller. However, it will understood higher bit depth DACs, for example 10-bit DACs, can be employed where greater resolution for the SLM is desired.

The triple HV output drivers 1014 are operable to receive three HV supplies 1016, one for each of the three MEMS-based linear arrays 1006a, 1006b, 1006c, and to couple three drive signals 1018 to each of the three MEMS-based linear arrays based on the analog voltage signals 1012 received from the triple DACs 1008. Each drive signal 1018 drives one or more active ribbons (not shown) in a single pixel 1004 in each of the three MEMS-based linear arrays 1006a, 1006b, 1006c. The difference in charge between the active ribbons and substrate electrodes 1020a, 1020b, 1020c underlying each linear array and coupled to a common voltage Vssc-R, Vssc-G, Vssc-B.

For the embodiment of the monolithic SLM 900 of shown FIG. 9, the drive circuit 1000 includes 1200 the triple DACs 1008 and 1200 triple HV output drivers 1014. Where active ribbons are slotted ribbons or include openings exposing a lower reflective surface as shown in FIGS. 8A and 8B, pixels 1004 can include a single active ribbon. Where the SLM is a flat GLV™, as shown in FIGS. 1A and 1B, each pixel can include one or more pairs of an active ribbon and a static ribbon. Where the SLM is a true light valve or GLV™, as shown in FIGS. 2A and 2B, each pixel can include one or more active ribbon and an equal exposed area of a lower reflective surface.

In another embodiment shown in FIG. 10B, the multi-driver architecture drive circuit 1000 includes a single 8-bit DAC 1008 is switchably coupled to the triple HV output drivers 1014 through a number of switches 1022. Only one analog voltage signals 1012 can be active at a time, for a duty cycle of 33% for each pixel 1004. Individual drive signals 1018 and HV supplies 1016 are available and can be used for each MEMS-based linear arrays 1006a, 1006b, 1006c, but the 8-bit digital imaging data 1010 and DAC transfer function is shared between all linear arrays.

In yet another embodiment shown in FIG. 10C, the multi-driver architecture drive circuit 1000 further includes a number of current mode sample and hold (S/H) circuits 1024 between the number of switches 1022 and the triple HV output drivers 1014. Adding S/H) circuits 1024 enables 100% duty cycle with single 8-bit DAC 1008 instead of a larger more complex triple DAC. As with the embodiment shown in FIG. 10B, Individual drive signals 1018 and HV supplies 1016 are available and can be used for each MEMS-based linear arrays 1006a, 1006b, 1006c, but the 8-bit digital imaging data 1010 and DAC transfer function is shared between all linear arrays.

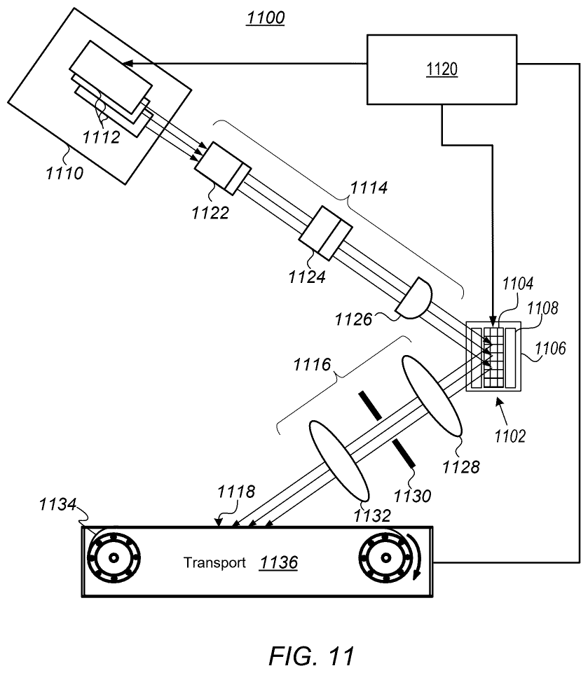

FIG. 11 is a schematic block diagram of an optical system 1100 including a monolithic SLM 1102 with multiple dimensionally and electrically tuned MEMS-based linear arrays 1104 on a substrate 1106, and a drive circuit 1108 integrally formed in the substrate below a surface thereof. Referring to FIG. 11, the optical system 1100 further includes an illuminator 1110 including multiple, coherent or narrow band light sources 1112, each light source operable to generate a light beam in a different, non-overlapping range of wavelengths or a specific wavelength, shaping or illumination optics 1114 operable to shape the light beams from each of plurality of light sources and to illuminate each of the linear arrays 1104 with the light beam from one of the light sources, imaging optics 1116 operable to transmit or image modulated light from each of the linear arrays onto an image plane 1118, and a controller 1120 operable to control the illuminator and the SLM. The coherent or narrow band light sources 1112 can include for example, red, green and violet-blue lasers. The illumination optics 1114 can include a Powell lens 1122, a long axis collimating lens 1124, and a cylindrical, short axis focusing lens 1126 to substantially uniformly illuminate a rectangular portion of a single linear array 1104 in the SLM 1102. The imaging optics 1116 can include a first Fourier Transform (FT) lens 1128, a spatial filter, such as a Fourier aperture 1130, to separate a 0^{th} order beam in the modulated light from ±1^{st} order beams and a second inverse Fourier Transform (FT) lens 1132. In some embodiments, the SLM 1102 further includes a cover (not shown in this figure) that includes one or more optical filter layers or cylindrical lenses that also function as an element of the illumination optics 1114 and imaging optics 1116.

In some embodiments the image plane 1118 can be on a movable media 1134, such as photographic film or paper, and the optical system 1100 further includes a transport mechanism 1136 controlled by the controller for moving the media 1134 across an imaging plane line-by-line or frame-by-frame at predetermined speed based on a duty cycle of the SLM.

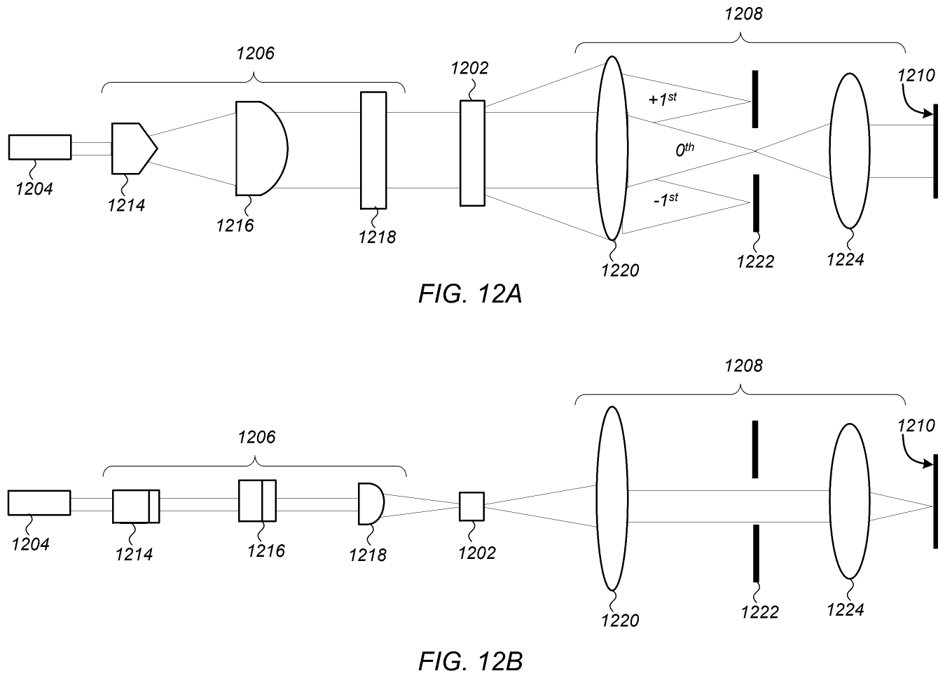

FIG. 12A and 12B are optic diagrams illustrating illumination and imaging light paths for illuminating and imaging one or more linear arrays of a monolithic a MEMS-based SLM 1202 in an optical system, such as that of FIG. 11. In particular, FIG. 12A is a top view illustrating the light paths along a longitudinal axis of a linear array in the SLM 1202, and FIG. 12B is a side view of the light path along a horizontal or short axis of the linear array. For purposes of clarity and to simplify the drawings the optical light path is shown as being unfolded causing the SLM 1202 to appear as transmissive. However, it will be understood that because the SLM 1202 is reflective the actual light paths are folded at an acute angle relative to one another and the SLM.

Referring to FIGS. 12A and 12B, the light path begins at a light source 1204, such as a laser, and passes through illumination optics 1206, to illuminate a substantially linear portion of a linear array in the SLM 1202, and imaging optics 1208 to focus the modulated light onto an imaging surface 1210. Generally, the illumination optics 1206 can include a Powell lens 1214, a long axis collimating lens 1216, and a cylindrical, short axis focusing lens 1218 to substantially uniformly illuminate a rectangular portion of a linear array in the SLM 1202 with a light-beam. The imaging optics 1208 generally includes a number of lenses and optical elements to direct amplitude or phase modulated light reflected from the SLM 1202 onto an imaging surface 1210 or objects in a far-field scene. In one embodiment, such as that shown, the imaging optics 1208 includes a first Fourier Transform (FT) lens 1220, a spatial filter, such as a Fourier aperture 1222, to separate a Oth order beam in the modulated light from ±1^{st} order beams and a second inverse Fourier Transform (FT) lens 1224.

It will be further understood that an optical system including a monolithic SLM 1202 with multiple MEMS-based linear arrays can include multiple instances of the illumination optics 1206 and imaging optics 1208, one for each linear array and associated light source 1204, offset by small angles, or can include a single instance of the illumination and imaging optics that is shared by each linear array by time division multiplexing. For example, narrow band light sources 1204 or lasers can pulsed at different times during a duty cycle of the SLM to enable sequential modulation of each of the different, non-overlapping range of wavelengths or a specific wavelength of light modulated by the multiple MEMS-based linear arrays.

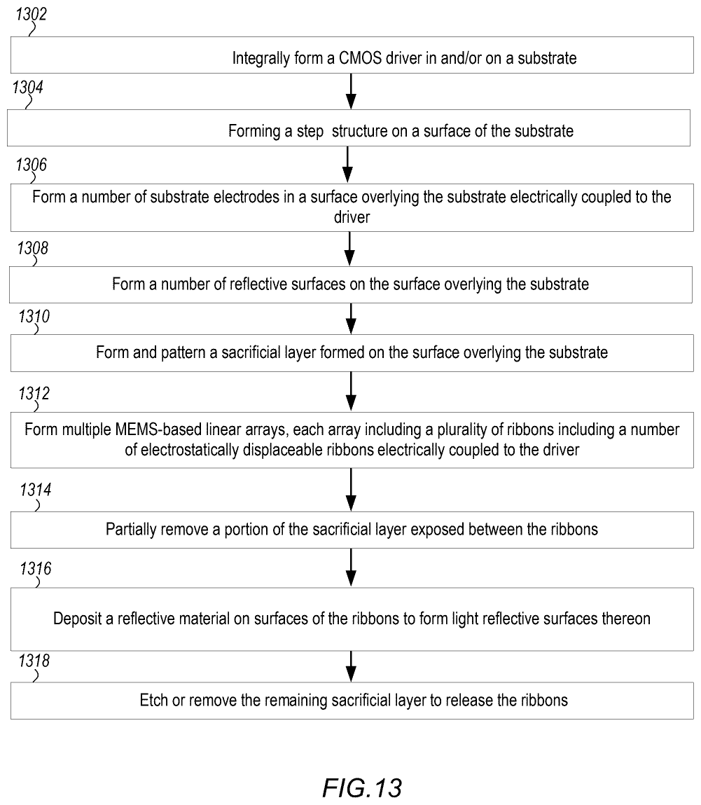

FIG. 13 is a flowchart of a method for fabricating a monolithic SLM including multiple dimensionally and electrically tuned MEMS-based linear arrays. Referring to FIG. 13, the method begins with integrally forming a CMOS drive circuit in and/or on a substrate (1302). Generally, the drive circuit includes multiple layers of vias, metal interconnect layers, and CMOS transistors or devices, formed in the substrate or in dielectric layers overlying the substrate. The drive circuit is formed using standard semiconductor fabrication techniques, and in particular using CMOS technology.

In embodiments in which the multiple MEMS-based linear arrays are to be dimensionally tuned by adjusting the gaps underlying the active ribbons in each linear array, a step structure is formed on the surface of the substrate (1304). The step structure can be formed using standard MEMS or semiconductor processing techniques. In one embodiment in which the multiple MEMS-based linear arrays are to include first, second and third linear arrays, the method involves deposition of a first and a second dielectric layer over the area in which the linear arrays will be fabricated, followed by a number of masking and selective etch steps to form the step structure shown in FIGS. 3D and 3E, and in 5D and 5F. The dielectric layer can include a silicon-dioxide, silicon nitride, or a silicon-oxynitride.

Next, a number of substrate electrodes are formed in or a surface overlying the substrate and electrically coupled to the drive circuit through vias and local interconnects (1306). The substrate electrodes can include titanium-nitride or doped polysilicon.

In embodiments in which the SLM is a true grating light valve or GLV™, or where the active ribbons are to include slots or openings therein, a number of reflective surfaces can be formed on the surface of the substrate (1308). The substrate or lower static reflective layer can include a thin layer of polysilicon or a metal, such as aluminum, formed and patterned as necessary using standard deposition and photolithographic techniques.

Next, a sacrificial layer, including a layer of material such as germanium, is then formed on the surfaces overlying the substrate and patterned (1310). Patterning the sacrificial layer generally includes forming a number of openings for posts and electrical contacts through which ribbon electrodes in the subsequently formed electrostatically displaceable ribbons will be electrically coupled to the drive circuit.

Multiple MEMS-based linear arrays are then formed on the surface of the substrate overlying the number of substrate electrodes (1312). Generally, this involves depositing a number of layers over the patterned sacrificial layer including a dielectric mechanical layer, which also fills a number of openings to form posts, an amorphous silicon-germanium layer to form the ribbon electrodes and electrical contacts through which ribbon electrodes are electrically coupled to the drive circuit. The SiGe electrode layer and the dielectric mechanical layer are then patterned to form multiple ribbons.

Next, a portion of the germanium sacrificial layer exposed between the ribbons is partially removed or gouged (1314). Generally, the removal is accomplished using an isotropic wet etch process. In one embodiment the wet etch uses 30% hydrogen peroxide (H₂O₂) metal etch, followed by a post-etch residue remover, such as EKC265™ commercially available from DuPont.

A reflective surface is formed on the (1316). Generally, the reflective surface is formed by depositing a thin layer of a reflective material, such as aluminum (Al), aluminum-copper (AlCu), gold (Au), silver (Ag) or any other suitably reflective metal, by a physical vapor deposition (PVD) process, such as sputtering.

Finally, the germanium sacrificial layer is etched or removed to fully release the ribbons (1318). As in the partial release step 1314, the release can be accomplished using an isotropic wet etch process of 30% hydrogen peroxide (H₂O₂) metal etch, followed by a post-etch residue remover, such as EKC265™.

Thus, monolithic MEMS-based SLM including multiple MEMS-based linear arrays formed on a surface of a substrate and a drive circuit integrally formed in the substrate, each array dimensionally and/or electrically tuned to modulate a different, non-overlapping range of wavelengths or a specific wavelength, have been disclosed. Embodiments of the present invention have been described above with the aid of functional and schematic block diagrams illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be understood that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

What is claimed is:

1. A spatial light modulator (SLM), comprising:
a substrate including a number of substrate electrodes in a surface thereof;
multiple microelectromechanical systems (MEMS)-based linear arrays formed on the surface of the substrate, each including a plurality of ribbons suspended above the surface of the substrate, each ribbon comprising a light reflective surface facing away from the surface of the substrate, the plurality of ribbons including electrostatically displaceable ribbons, each electrostatically displaceable ribbon further comprising a ribbon electrode; and
a drive circuit monolithically integrated in the substrate below the surface of the substrate, the drive circuit electrically coupled to the number of substrate electrodes and the ribbon electrodes in the electrostatically displaceable ribbon, and operable to apply drive voltages thereto,
wherein each of the multiple MEMS linear arrays is dimensionally tuned to modulate a different, non-overlapping range of wavelengths.

2. The SLM of claim 1, wherein the multiple MEMS-based linear arrays comprise three MEMS-based linear arrays, including a first linear array tuned to modulate wavelengths of light in a visible spectrum corresponding to red light, a second linear array tuned to modulate wavelengths of light in the visible spectrum corresponding to violet-blue light, and a third linear array tuned to modulate wavelengths of light in the visible spectrum corresponding to green light.

3. The SLM of claim 2, wherein the electrostatically displaceable ribbons in each of the MEMS linear arrays comprise one or more of a length, a thickness, or a gap separating a central portion of the electrostatically displaceable ribbons from the surface of the substrate that is different from then plurality of electrostatically displaceable ribbons in the other MEMS linear arrays to dimensionally tune the linear array.

4. The SLM of claim 3 wherein the reflective surfaces of the plurality of ribbons in each of the multiple MEMS linear arrays are substantially co-planar in a quiescent state and the surface of the substrate comprises a stepped structure having a first portion underlying a first MEMS linear array to yield a first gap between the plurality of ribbons of the first MEMS linear array and the surface of the substrate, a second portion underlying a second MEMS linear array to yield a second gap between the plurality of ribbons of the second MEMS linear array and the surface of the substrate, and a third portion underlying a third MEMS linear array to yield a third gap between the plurality of ribbons of the third MEMS linear array and the surface of the substrate, and wherein the first gap is greater than the second gap and the second gap is greater than the third gap.

5. The SLM of claim 4 wherein the number of substrate electrodes comprises three separate electrodes including a first substrate electrode in the first portion underlying the first MEMS linear array, a second substrate electrode in the second portion underlying the second MEMS linear array, and a third substrate electrode in the third portion underlying the third MEMS linear array.

6. The SLM of claim 2, wherein each of three linear arrays is electrically tuned, and wherein the drive circuit comprises a multiple driver architecture including a plurality of triple digital-to-analog-converters (DACs) and a plurality of triple high voltage (HV) output drivers, each triple DAC and triple HV output driver operable to receive digital image data for each of the three linear arrays and to couple to couple three, unique drive signals to the three MEMS-based linear arrays to drive a single pixel in each of the three linear arrays to modulate light in a different, non-overlapping range of wavelengths from the rest of the multiple arrays.

7. The SLM of claim 1, wherein the drive circuit comprises a multiple driver architecture including a plurality of digital-to-analog-converters (DACs), each DAC switchable coupled to one of a plurality of triple high voltage (HV) output drivers, each DAC operable to receive digital image data and each triple HV output driver operable to couple three, unique drive signals to the three MEMS-based linear arrays to a drive a single pixel in each of the three MEMS-based linear arrays to modulate light in a different, non-overlapping range of wavelengths from the rest of the multiple arrays.

8. The SLM of claim 7 wherein the drive circuit further comprises multiple sample and hold (S/H) circuits coupled between one of the plurality of triple HV output drivers, wherein each S/H circuit is operable to receive an analog voltage signal from the DAC and couple the voltage to one of the plurality of triple HV output driver to drive a single pixel in each of the three MEMS-based linear arrays for a full duty cycle.

9. The SLM of claim 1, wherein the drive circuit comprises a multiple drive circuit architecture including multiple digital-to-analog-converters (DACs), each DAC switchably coupled to a number of pixels in each of the multiple linear arrays, the DAC operable to receive digital image data and to generate a voltage to sequentially drive the number of pixels in each of the multiple linear arrays for fraction of a duty cycle equal to 1/n, where n is the number of multiple linear arrays.

10. An optical system comprising:
an illuminator including a plurality of light sources, each light source operable to generate a light beam in a different, non-overlapping range of wavelengths;
a monolithic spatial light modulator (SLM) comprising:
a substrate including a number of substrate electrodes in a surface thereof; and
multiple microelectromechanical systems (MEMS)-based linear arrays formed on a surface of a substrate, each linear array operable to receive the light beam from a different one of the plurality of the light sources and dimensionally tuned to modulate different, non-overlapping range of wavelengths;
illumination optics operable to shape the light beams from each of plurality of light sources and to illuminate each of the linear array with the light beam from one of the plurality of light sources;
imaging optics operable to selectively filter modulated light from each of the linear arrays and to transmit the filtered modulated onto an image plane; and
a controller operable to control the illuminator and the SLM.

11. The optical system of claim 10, wherein each of the linear arrays including a plurality of ribbons suspended above the surface of the substrate, each ribbon comprising a light reflective surface facing away from the surface of the substrate, the plurality of ribbons including electrostatically displaceable ribbons, each electrostatically displaceable ribbon further comprising a ribbon electrode, and further comprising a drive circuit monolithically integrated in the substrate below the surface of the substrate, the drive circuit electrically coupled to the number of electrode and the ribbon electrodes in the electrostatically displaceable ribbon, and operable to apply drive voltages thereto.

12. The optical system of claim 11 wherein the electrostatically displaceable ribbons in each of the MEMS linear arrays comprise one or more of a length, a thickness or gap separating a central portion of the electrostatically displaceable ribbons from the surface of the substrate that is different from then plurality of electrostatically displaceable ribbons in the other MEMS linear arrays.

13. The optical system of claim 12 wherein the reflective surfaces of the plurality of ribbons in each of the multiple MEMS linear arrays are substantially co-planar in a quiescent state and the surface of the substrate comprises a stepped structure having a first portion underlying a first MEMS linear array to yield a first gap between the plurality of ribbons of the first MEMS linear array and the surface of the substrate, a second portion underlying a second MEMS linear array to yield a second gap between the plurality of ribbons of the second MEMS linear array and the surface of the substrate, and a third portion underlying a third MEMS linear array to yield a third gap between the plurality of ribbons of the third MEMS linear array and the surface of the substrate, and wherein the first gap is greater than the second gap and the second gap is greater than the third gap.

14. The optical system of claim 11, wherein the multiple MEMS-based linear arrays includes three linear arrays, and wherein each of three linear arrays is electrically tuned, and wherein the drive circuit comprises a multiple driver architecture including a plurality of triple digital-to-analog-converters (DACs) and a plurality of triple high voltage (HV) output drivers, each triple DAC and triple HV output driver operable to receive digital image data for each of the three linear arrays and to couple to couple three, unique drive signals to the three MEMS-based linear arrays to drive a single pixel in each of the three linear arrays to modulate light in a different, non-overlapping range of wavelengths from the rest of the multiple arrays.

15. The optical system of claim 11, wherein the drive circuit comprises a multiple driver architecture including a plurality of digital-to-analog-converters (DACs), each DAC switchable coupled to one of a plurality of triple high voltage (HV) output drivers, each DAC operable to receive digital image data and each triple HV output driver operable to couple three, unique drive signals to the three MEMS-based linear arrays to a drive a single pixel in each of the three MEMS-based linear arrays to modulate light in a different, non-overlapping range of wavelengths from the rest of the multiple arrays.

16. The optical system of claim 15, wherein the drive circuit further comprises multiple sample and hold (S/H) circuits coupled between one of the plurality of triple HV output drivers, wherein each S/H circuit is operable to receive an analog voltage signal from the DAC and couple the voltage to one of the plurality of triple HV output driver to drive a single pixel in each of the three MEMS-based linear arrays for a full duty cycle.

17. The optical system of claim 11, wherein the drive circuit comprises a multiple drive circuit architecture including multiple digital-to-analog-converters (DACs), each DAC switchably coupled to a number of pixels in each of the multiple linear arrays, the DAC operable to receive digital image data and to generate a voltage to sequentially drive the number of pixels in each of the multiple linear arrays for fraction of a duty cycle equal to 1/n, where n is the number of multiple linear arrays.

18. A method for fabricating a monolithic spatial light modulator (SLM) comprising steps of:
forming a drive circuit in a substrate;
forming a number of substrate electrodes in a surface of the substrate, the number of substrate electrodes electrically coupled to the drive circuit;
forming a sacrificial layer over the surface of the substrate;
forming multiple microelectromechanical systems (MEMS)-based linear arrays on the surface of the substrate overlying the number of substrate electrodes, each linear array including a plurality of ribbons formed on the sacrificial layer, parallel to one another and the surface of the substrate, and perpendicular to a long axis of the linear array, each ribbon comprising a light reflective surface facing away from the surface of the substrate, the plurality of ribbons including electrostatically displaceable ribbons, each electrostatically displaceable ribbon comprising a ribbon electrode; and
removing the sacrificial layer to release the plurality of ribbons,
wherein each of the multiple MEMS linear arrays is dimensionally tuned to modulate a different, non-overlapping range of wavelengths.

19. The method of claim 18 wherein the electrostatically displaceable ribbons in each of the MEMS linear arrays comprise one or more of a length, a thickness, or a gap separating a central portion of the electrostatically displaceable ribbons from the surface of the substrate that is different from then plurality of electrostatically displaceable ribbons in the other MEMS linear arrays, to dimensionally tune each of the multiple MEMS linear arrays to modulate a different, non-overlapping range of wavelengths.

20. The method of claim 19 wherein the surface of the substrate comprises a stepped structure having a first portion underlying a first MEMS linear array to yield a first gap between the plurality of ribbons of the first MEMS linear array and the surface of the substrate, a second portion underlying a second MEMS linear array to yield a second gap between the plurality of ribbons of the second MEMS linear array and the surface of the substrate, and a third portion underlying a third MEMS linear array to yield a third gap between the plurality of ribbons of the third MEMS linear array and the surface of the substrate, and wherein the first gap is greater than the second gap and the second gap is greater than the third gap.
